(19) United States
(12) Patent Application Publication
(10) Pub. No.: US 2022/0314098 A1
(43) Pub. Date: Oct. 6, 2022

(54) GAME DEVICE

(71) Applicant: LYMB.iO GmbH, Muenchen (DE)

(72) Inventor: Markos Aristides Kern, Muenchen (DE)

(21) Appl. No.: 17/848,363

(22) Filed: Jun. 23, 2022

Related U.S. Application Data
(63) Continuation of application No. PCT/EP2020/087488, filed on Dec. 21, 2020.

(30) Foreign Application Priority Data
Dec. 23, 2019 (DE) 10 2019 135 695.4
Apr. 3, 2020 (DE) 10 2020 109 414.0

(51) Int. Cl. A63B 71/06

(52) U.S. Cl. CPC A63B 71/0605; A63B 2071/0694

(57) ABSTRACT

A game device includes a display surface, a game space assigned to the display surface, a sensor system configured to detect an impact site of an object on the display surface, an acquisition system configured to detect the position of the object and/or of a player in at least a part of the game space, and a computing unit configured to determine a target field on the display surface using the position, wherein the game device is configured to display the target field on the display surface and to determine whether the impact site lies in the target field.

### CROSS REFERENCE TO RELATED APPLICATIONS

This application is a continuation application of international patent application PCT/EP2020/087488, filed Dec. 21, 2020, designating the United States and claiming priority to German applications 10 2019 135 695.4, filed Dec. 23, 2019, and 10 2020 109 414.0, filed Apr. 3, 2020, and the entire content of these applications is incorporated herein by reference.

### TECHNICAL FIELD

The disclosure relates to a game device.

### BACKGROUND

A rebound sport is a ball sport in which two players or teams pass an object such as, for example, a ball to one another via a wall while observing a particular set of rules and in the process attempt to force the opponent to make mistakes when receiving or returning the ball. Mistakes by one side result in points going to the other side and/or give this other side the right to serve. Squash is a rebound sport. Rebound sport is also understood to mean that a single player passes the object to himself via a wall. The wall can be a flat or curved surface or an edge. Object is to be understood to mean any means that can be played against the wall in order to bounce back from it. Game devices are known for rebound sport in which target fields are displayed on the wall that the player is to hit with the ball. The target fields can be varied here over time.

### SUMMARY

It is an object of the disclosure to improve the known game devices.

The game device according to an aspect of the disclosure includes a display surface, a game space assigned to the display surface, a sensor system that is configured to detect an impact site of an object on the display surface, an acquisition system that is configured to detect the position of the object and/or of a player in at least a part of the game space, and a computing unit that is configured to determine a target field on the display surface using the position, wherein the game device is configured to display the target field on the display surface and to determine whether the impact site lies in the target field.

It is now possible with the game device according to the disclosure to determine the target fields adjusted to the position of the object and/or of the player. This opens many new ways in which to control a game played by the player. It is possible at the same time, using the sensor system, to determine whether the impact site lies in the target field, i.e. whether the object has hit the target field. An improved game device is thus provided. The game can, for example, be controlled in such a way that it is variable. It is thus, for example, possible to determine the target field in such a way that the player, when he has played the object in such a way that the impact site lies in the target field, must always take some steps in order to subsequently reach the object again.

The acquisition system typically includes a depth camera. The depth camera is configured to record a two-dimensional or three-dimensional image of the game space, wherein each image point of the two-dimensional or three-dimensional image represents a distance value. The distance value can, for example, be the distance of a point of the object and/or of the player from the depth camera. The depth camera can, for example, be configured to determine the distance with a time-of-flight measurement of an electromagnetic pulse.

Alternatively or in addition, the acquisition system can include a laser scanner and/or a touch-sensitive floor. The laser scanner can also be configured to determine a distance of a point of the object and/or of the player from the laser scanner. The touch-sensitive floor can bound the game space at its lower end and be configured to determine the position of the object and/or of the player through their contact with the touch-sensitive floor.

The game device typically includes a projector that is configured to project the target field onto the display surface. It is particularly easily possible with the projector to retrofit an existing game space such as, for example, a squash court and thus to convert it into the game device according to an aspect of the disclosure. Alternatively, the game device typically includes a screen that includes the display surface.

The object is typically a real object. As an alternative to this, the object is typically a virtual object.

According to a first exemplary embodiment of the sensor system, the sensor system typically includes a first row of photoelectric sensors arranged in parallel that is configured to determine a y-coordinate of the impact site. The sensor system can include a camera that is configured to determine a z-coordinate of the impact site. As an alternative to the camera, the sensor system can include a second row of photoelectric sensors arranged in parallel that is configured to determine the z-coordinate of the impact site. According to the first exemplary embodiment, the object is the real object.

According to a second exemplary embodiment of the sensor system, the sensor system typically includes a camera that is configured to determine a y-coordinate and a z-coordinate of the impact site. According to the second exemplary embodiment, the object is the real object.

In a third exemplary embodiment of the sensor system, the game device can include the screen, which is implemented as a touchscreen and thus forms at least part of the sensor system. The touchscreen can be configured to detect a y-coordinate and a z-coordinate of the impact site. The touchscreen can, for this purpose, for example, include pressure sensors, light sensors, a touch-sensitive membrane and/or a touch-sensitive electronic paint. According to the third exemplary embodiment, the object is the real object.

In a fourth exemplary embodiment of the sensor system, the sensor system can at least partially be formed by the acquisition system, and the sensor system can be configured to derive the impact site from the position and/or a movement of a player. A stroke with a tennis racquet can, for example, be simulated for this purpose from an arm movement of the player. According to the fourth exemplary embodiment, the object is the virtual object.

In all of the exemplary embodiments of the sensor system, the y-axis belonging to the y-coordinate can be arranged perpendicular to the z-axis belonging to the z-coordinate. In all of the exemplary embodiments of the sensor system, the y-axis can be arranged horizontally and the z-axis can be arranged vertically.

The game space is typically adjacent to the display surface.

The computing unit is typically a personal computer and/or a server. The computing unit can be configured to determine whether the impact site lies in the target field. It is alternatively conceivable that the game device includes a further computing unit that is configured to determine whether the impact site lies in the target field. The further computing unit can also be a personal computer and/or a server.

It is typical that the object is a flying object.

It is typical that the object is a ball, a medicine ball or a frisbee.

The game device typically includes the object.

It is typical that the computing unit is configured to determine a target area arranged in the game space on the basis of a predetermined rule using the position, and, using the target area, the position, and a ballistic model of the object, to determine the target field in such a way that when the player plays the object towards the target field, the object enters the target area after bouncing back from the display surface. The predetermined rule can, for example, be selected such that the target area is arranged at the position of the player. The consequence of this is that the player does not have to move, or only has to move slightly, to reach the object. This makes it possible for the player to be able to concentrate on the play of the object. Alternatively, the predetermined rule can, for example, be selected such that the target area is arranged at a position other than the position of the player. As a result, after having played the object, the player must change his position to reach the object, whereby, in particular, the fitness of the player is trained. The computing unit here can be configured as a client-computing unit, with which the predetermined rule can be entered into the computing unit and/or manipulated remotely, in particular via the server. It is possible in this way to change the predetermined rule quickly and/or variably.

The computing unit is typically configured to determine a target point representative for the target area, to calculate, using the ballistic model, a trajectory of the object extending from the position of the object via the display surface to the target point, and to determine the target field about an intersection point of the trajectory on the display surface. The larger the target field that the computing unit now determines, the larger is the game space thereby determined. The intersection point can, for example, be arranged at the center of gravity of the target field.

The target area or the target point can be determined in such a way that the target area or the target point change when the position changes. As an alternative to this, it is conceivable that the target area or the target point are determined on the basis of the position that the object and/or the player have at a predetermined time point. The predetermined time point can, for example, coincide with the time point at which the object impacts the display surface, or be determined with a predetermined time delay from the time point at which the object impacts the display surface. It is, alternatively, conceivable that the predetermined time point coincides with the time point at which the object changes its direction of movement in a direction away from the display surface to a direction towards the display surface, or is determined with a predetermined time delay from the time point at which the object impacts the display surface.

It is typical that in the case in which the acquisition system is not configured to determine the position of the object, the computing unit is configured to determine the position of the object depending on the position of the player. For example, the computing unit can be configured to equate the position of the object to the position of the player. In an alternative example, the computing unit can be configured to determine the position of the object in accordance with a predetermined calculation rule at a position other than the position of the player. It is conceivable here that the acquisition system is configured to distinguish whether the player is holding a racquet in a forehand or in a backhand, and that the predetermined calculation rule is different according to whether the player is holding the racquet in the forehand or in the backhand.

It is typical that the ballistic model describes a force-free movement of the object. This advantageously involves a ballistic model requiring particularly little computation. The computing unit can be configured here to calculate the trajectory using the position of the object and of the target point as well as taking the reflection of the object at the display surface into consideration. It is not necessary here for a speed to be determined for the object. It is conceivable here that the ballistic model takes an energy loss of the kinetic energy of the object due to the bouncing-back from the display surface into consideration. The ballistic model thereby becomes particularly realistic, so that the object, if it is played into the target field, reaches the target area with a high probability.

It is alternatively typical that the ballistic model includes an acceleration due to gravity. The ballistic model thereby becomes particularly realistic, so that the object, if it is played into the target field, reaches the target area with a high probability. It is typical that the ballistic model takes an energy loss of the kinetic energy of the object due to the bouncing-back from the display surface into consideration. The ballistic model thereby becomes particularly realistic, so that the object, if it is played into the target field, reaches the target area with a high probability. In addition, it is typical that the ballistic model takes an air friction resistance into consideration. The probability that the object reaches the target area when it is played into the target field is particularly high if the ballistic model takes a plurality or all of the acceleration due to gravity, the energy loss of the kinetic energy of the object due to the bouncing-back from the display surface, and the air friction resistance into consideration.

The ballistic model typically includes an initial speed for the object at the position of the object or a final speed for the object at the target point. A usual initial speed occurring when playing the object can be selected for the initial speed. This can, for example, be a usual speed with which the player hits a squash ball or a tennis ball with a racquet, throws a handball or kicks a football. A usual speed occurring after the bouncing-back in the target area or at the target point can be selected for the final speed. Because the ballistic model includes the initial speed or the final speed, it is not necessary to measure a speed of the object, so that the target field can be determined and displayed before the player plays the object. The trajectory can now, for example, be calculated in that the motion equation is solved with the position of the object and the initial speed as the initial conditions of the motion equation. The direction of the object belonging to the initial speed can be varied until the trajectory enters an acceptance region around the target point. Alternatively, the motion equation can be solved with the position of the object, the target point and the final speed as the boundary conditions.

It is typical that a plurality of the predetermined rules are stored in the computing unit, each of which has a different degree of difficulty for the player when playing with the game device. By choosing the previously determined rule, it is now possible to change the degree of difficulty.

The acquisition system is typically configured to determine the number of players.

It is typical that the acquisition system is configured to determine the number of players, and a different one of the predetermined rules or a different set of the predetermined rules is stored in each case in the computing unit for each number of players. It is thereby possible to adjust the predetermined rules to the number of players automatically.

The acquisition system is typically configured to determine the positions of at least the object and of the player or of at least two of the objects or of at least two of the players. In particular this opens many new ways in which to control a game.

It is typical that the acquisition system is configured to determine the positions of at least two of the players, and the computing unit is configured to determine the target area using the positions of the at least two of the players. It is thereby possible to control the game in such a way that it is improbable that the at least two of the players will collide, whereby a risk of injury is low. It is thus, for example, possible to determine the target field in such a way that one of the players must move away from the other one of the players or must only move a small distance towards the other players in order to reach the object.

The acquisition system is typically configured to determine an eye point position of an eye point of the player in the part of the game space and to adjust the perspective of an image displayed on the display surface to the eye point position. When using the game device, the player thus has a particularly good visual experience. The acquisition system can be configured to determine the position of both eyes of the player and to determine the eye point position as the center point of the positions of the two eyes. Equally, the acquisition system can be configured to detect the head and to determine the eye point position, for example, as the center point of the head or as the center point of a surface that is located at the end of the head that is facing the display surface.

The acquisition system is typically configured to recognize whether the object was played by a hand of the player or by a foot of the player. In the case in which the object was played by the hand, a different predetermined rule or a different set of the predetermined rules can be provided to the computing unit from the case in which the object was played by the foot.

It is typical that the acquisition system is configured to recognize whether the player is holding a racquet in the hand and in particular whether the object was played by the racquet. In the case in which the player is holding the racquet in the hand, a different predetermined rule or a different set of the predetermined rules can be provided to the computing unit from the case in which the object was played by the hand or the foot.

It is typical that the acquisition system is configured to recognize whether the object was played in accordance with a set of rules belonging to the game device. Cheating the game can thereby be prevented.

The game device is typically configured such that a rebound sport, in particular squash, tennis, volleyball, a shooting sport, in particular archery, or American football can be played with the game device.

An apparatus according to an aspect of the disclosure includes two of the game devices according to another aspect of the disclosure or two exemplary embodiments of the game device according to an aspect of the disclosure, wherein the apparatus is configured to display the position acquired in one of the game devices in the other one of the game devices. The two game devices can be installed at different locations, such that two of the players or two teams can play against one another or with one another over a large distance. The position can be displayed on the display surface of the other one of the game devices. It is typical that the apparatus is configured to display the positions acquired in both game devices respectively in the other game device, in particular on its display surface.

### BRIEF DESCRIPTION OF THE DRAWINGS

The disclosure will now be described with reference to the drawings wherein:

FIG. 1 shows a perspective view of a game device.

FIG. 2 shows a first exemplary embodiment for a predetermined rule.

FIG. 3 shows a second exemplary embodiment for the predetermined rule.

FIG. 4 shows a third exemplary embodiment for the predetermined rule.

### DESCRIPTION OF EXEMPLARY EMBODIMENTS

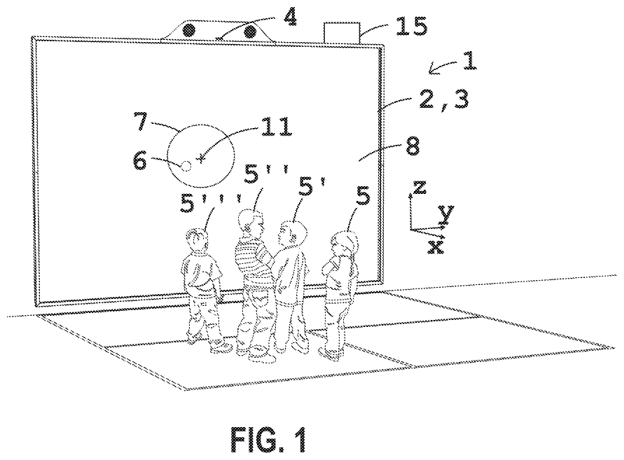

As can be seen in FIG. 1, a game device 1 includes a display surface 2, a game space 8 assigned to the display surface 2, a sensor system 3 that is configured to detect an impact site 11 of an object 6 on the display surface 2, an acquisition system 4 that is configured to detect the position of the object 6 and/or of a player 5 in at least a part of the game space 8, and a computing unit 15 that is configured to determine a target field 7 on the display surface 2 using the position. The game device 1 is configured to display the target field 7 on the display surface 2 and to determine whether the impact site 11 lies in the target field 7. The game space 8 can be adjacent to the display surface 2. The computing unit 15 can be a personal computer and/or a server. The computing unit can be configured to determine whether the impact site lies in the target field. It is alternatively conceivable that the game device includes a further computing unit that is configured to determine whether the impact site lies in the target field. The further computing unit can also be a personal computer and/or a server. The object can be a flying object. For this purpose, the object 6 can be a ball, a medicine ball or a frisbee. The game device 1 can include the object 6. It is conceivable that the target area 12 extends from a lower end to an upper end of the game space 8. It is also conceivable that the target area 12 only extends in a part of the extent of the full height of the game space 8.

An exemplary coordinate system with an x-axis, a y-axis and a z-axis, each of which is arranged perpendicularly to one another, is shown in FIG. 1. The x-axis and the y-axis are arranged horizontally, and the z-axis is arranged vertically. The normal to the display surface 2 is arranged parallel to the x-axis.

FIG. 1 shows that the acquisition system 4 can, for example, be arranged at an upper end of the display surface 2. It is conceivable that the acquisition system 4 includes a depth camera. The depth camera is configured to record a two-dimensional or three-dimensional image of the game space 8, wherein each image point of the two-dimensional or three-dimensional image represents a distance value. The distance value can, for example, be the distance of a point of the object 6 and/or of the player 5 from the depth camera. The depth camera can, for example, be configured to determine the distance with a time-of-flight measurement of an electromagnetic pulse.

Alternatively or in addition, the acquisition system 4 can include a laser scanner and/or a touch-sensitive floor 13. The laser scanner can also be configured to determine a distance of a point of the object 6 and/or of the player 5 from the laser scanner. The touch-sensitive floor 13 can bound the game space 8 at its lower end and be configured to determine the position of the object 6 and/or of the player 5 through their contact with the touch-sensitive floor 13.

The game device 1 can include a projector that is configured to project the target field 7 onto the display surface 2. Alternatively, the game device 1 can include a screen that includes the display surface 2.

The object can be a real object. It is furthermore conceivable that the object is a virtual object.

According to a first exemplary embodiment of the sensor system 3, the sensor system 3 can include a first row of photoelectric sensors arranged in parallel that is configured to determine a y-coordinate, belonging to the y-axis shown in FIG. 1, of the impact site 11. The sensor system 3 can include a camera that is configured to determine a z-coordinate, belonging to the z-axis shown in FIG. 1, of the impact site 11. The camera can be configured to use the speed and the direction of the object 6 before and after bouncing back from the impact site 11 to determine the z-coordinate. As an alternative to the camera, the sensor system 3 can include a second row of photoelectric sensors arranged in parallel that is configured to determine the z-coordinate of the impact site 11. According to the first exemplary embodiment, the object can be the real object.

According to a second exemplary embodiment of the sensor system 3, the sensor system 3 typically includes a camera that is configured to determine a y-coordinate, belonging to the y-axis shown in FIG. 1, and a z-coordinate, belonging to the z-axis shown in FIG. 1, of the impact site 11. According to the second exemplary embodiment, the object can be the real object.

In a third exemplary embodiment of the sensor system 3, the game device 1 can include the screen, which is implemented as a touchscreen and thus forms at least part of the sensor system 3. The touchscreen can be configured to determine a y-coordinate, belonging to the y-axis shown in FIG. 1, and a z-coordinate, belonging to the z-axis shown in FIG. 1, of the impact site 11. According to the third exemplary embodiment, the object can be the real object.

In a fourth exemplary embodiment of the sensor system 3, the sensor system 3 can at least partially be formed by the acquisition system 4, and the sensor system 3 can be configured to derive the impact site from the position and/or a movement of a player 5. A stroke with a tennis racquet can, for example, be simulated for this purpose from an arm movement of the player 5. According to the fourth exemplary embodiment, the object is the virtual object.

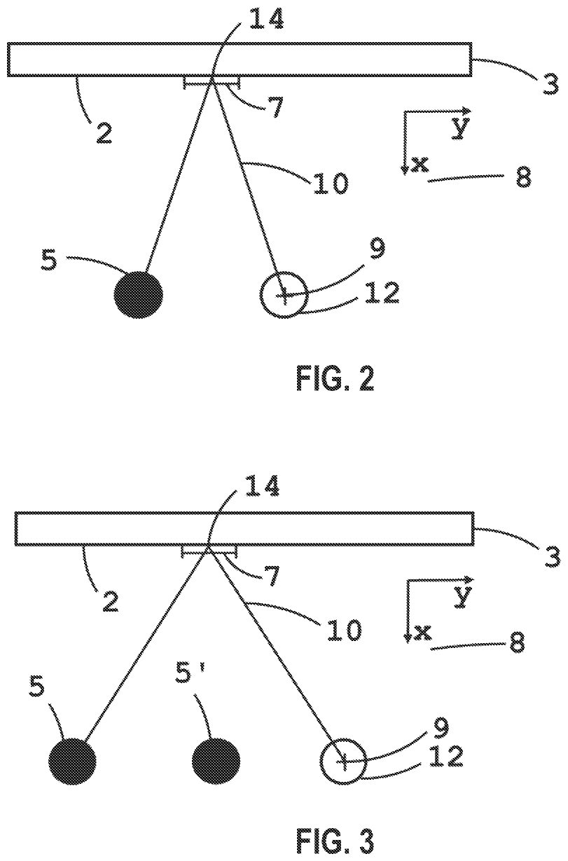

FIGS. 2 to 4 show that the computing unit 15 can be configured to determine a target area 12 arranged in the game space 8 on the basis of a predetermined rule using the position, and, using the target area 12, the position, and a ballistic model of the object 6, to determine the target field 7 in such a way that when the player 5 plays the object 6 towards the target field 7, the object 6 enters the target area 12 after bouncing back from the display surface 2. For this purpose, the computing unit 15 can be configured to determine a target point 9 representative for the target area 12, to calculate, using the ballistic model, a trajectory 10 of the object 6 extending from the position of the object 6 via the display surface 2 to the target point 9, and to determine the target field 7 about an intersection point 14 of the trajectory 10 on the display surface 2. The computing unit 15 here can be configured as a client-computing unit, with which the predetermined rule can be entered into the computing unit 15 and/or manipulated remotely, in particular via the server.

To determine the trajectory 10, the acquisition system 4 can be configured to determine the position of the object 6. In the alternative case in which the acquisition system 4 is not configured to determine the position of the object 6, the computing unit 15 can be configured to determine the position of the object 6 depending on the position of the player 5. It is, for example, conceivable that the computing unit 15 is configured to equate the position of the object 6 to the position of the player 5, as is, for example, shown in FIGS. 2 to 4. It is alternatively conceivable that the computing unit 15 can be configured to determine the position of the object 6 in accordance with a predetermined calculation rule at a position other than the position of the player 5. It is conceivable here that the acquisition system 4 is configured to distinguish whether the player 5 is holding a racquet in a forehand or in a backhand, and that the predetermined calculation rule is different according to whether the player 5 is holding the racquet in the forehand or in the backhand.

It is conceivable that the ballistic model describes a force-free movement of the object 6. It is conceivable here that the computing unit 15 is configured to determine the trajectory 10 without using a speed of the object. Alternatively, it is conceivable that the ballistic model takes occurring forces into consideration in the calculation of the trajectory 10. It is conceivable here that the computing unit 15 is configured to take a speed of the object 6 into consideration. It is conceivable here that the ballistic model includes an initial speed for the object 6 at the position of the object, or a final speed for the object 6 at the target point 9. To take the occurring forces into consideration, the ballistic model can include an acceleration due to gravity, take an air friction resistance into consideration and/or take an energy loss of the kinetic energy of the object 6 due to the bouncing-back from the display surface 2 into consideration.

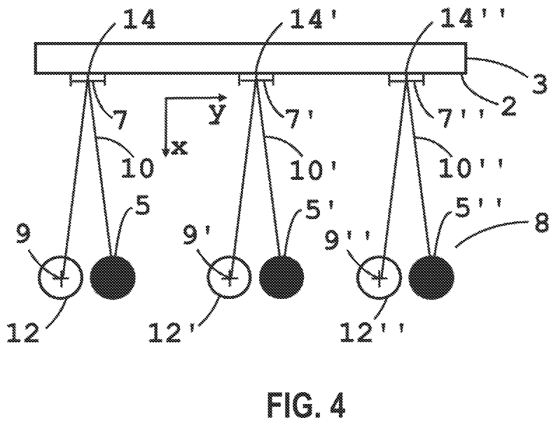

Three exemplary embodiments for the predetermined rule are shown in FIGS. 2 to 4, wherein the predetermined rule according to FIG. 2 relates to a game in which only one of the players 5 is located in the game space 8, the predetermined rule according to FIG. 3 relates to a game in which precisely two of the players 5, 5′ are located in the game space 8, and the predetermined rule according to FIG. 4 relates to a game in which precisely two of the players 5, 5′ or more than two of the players 5, 5′, 5″ are located in the game space 8. According to FIG. 3, the game is played by the players 5, 5′, 5″ with one another and with only one object 6, whereas according to FIG. 4, the game is played by players 5, 5′, 5″ next to one another with one respective object 6 for each of the players 5, 5′, 5″.

For the exemplary embodiment shown to FIG. 2, the target field 7 is selected in such a way that a straight line that runs parallel to the x-axis and through the intersection point 14 runs next to the player 5. As a result, after the player 5 has played the object 6 into the target field 7, he must move in order to subsequently reach the object 6 again. It is alternatively conceivable that a straight line that runs parallel to the x-axis and through the intersection point 14 meets the player 5. It is conceivable that a plurality of the predetermined rules are stored in the computing unit 15, each of which has a different degree of difficulty for the player 5 when playing with the game device 1. Thus, for example, as the degree of difficulty increases, the distance from the position to the target area 12 can be chosen to be longer and longer.

In the exemplary embodiment shown to FIG. 3, the acquisition system 2 is configured to determine the positions of two of the players, namely a first player 5 and a second player 5′. In addition, the computing unit 15 is configured to determine the target area 12 using the positions of the first player 5 and of the second player 5′. The first player 5 plays the object 6 at the display surface, and the second player 5′ should reach the object 6. The target area 12 can now be selected such that the target area 12 is arranged at the side of the second player 5′ that faces away from the first player 5. The second player 5′ must therefore move away from the first player 5 in order to reach the object 6. It is alternatively conceivable that the target area 12 is arranged at the position of the second player 5′. The second player 5′ can therefore concentrate on playing the object 6. It is also conceivable that the target area 12 is arranged between the first player 5 and the second player 5′. The second player 5′ must therefore move towards the first player 5 in order to reach the object 6. It is also conceivable that according to the predetermined rule, in a sequence of game plays, there is an alternation between the target area 12 that is arranged on the side of the second player 5′ that faces away from the first player 5, the target area 12 that is arranged at the position of the second player 5′, and/or the target area 12 that is arranged between the first player 5 and the second player 5′. It is conceivable that a plurality of the predetermined rules are stored in the computing unit 15, each of which has a different degree of difficulty for the second player 5′ when playing with the game device 1. Thus, for example, as the degree of difficulty increases, the distance of the target area 12 from the position of the second player 5′ can be chosen to be longer and longer.

In the exemplary embodiment shown to FIG. 3, the acquisition system 4 is configured to determine the positions of at least two of the players 5, 5′, 5″. In addition, the computing unit 15 is configured to determine a target area 12 for each of the players 5, 5′, 5″ using the positions in each case. The target area 12 of each of the players 5, 5′, 5″ can be determined in such a way that the target area 12 is arranged between the players 5, 5′, 5″ belonging to the target area 12 and his neighboring players 5, 5′, 5″, or, in the case in which the player 5″ only has one neighboring player 5′, is arranged on the side of the player 5″ facing away from the neighboring player 5′. It is conceivable that a plurality of the predetermined rules are stored in the computing unit 15, each of which has a different degree of difficulty for the players 5, 5′, 5″ when playing with the game device 1. Thus, for example, as the degree of difficulty increases, the distance from the position to the target area 12 can be chosen to be longer and longer.

The acquisition system 4 can be configured to determine the number of players 5. Another of the predetermined rules or another set of the predetermined rules can, moreover, be stored in the computing unit 15 for each number of players 5 in each case. For example, the predetermined rules or the sets of the predetermined rules can be the predetermined rules described for FIGS. 2 to 4.

The acquisition system can be configured to determine an eye point position of an eye point of the player 5 in the part of the game space 8 and to adjust the perspective of an image displayed on the display surface 2 to the eye point position. For this purpose, the acquisition system can for example be configured to determine the position of both eyes of the player 5 and to determine the eye point position as the center point of the positions of both eyes. Equally, the acquisition system can, for example, be configured to detect the head and to determine the eye point position, for example, as the center point of the head or as the center point of a surface that is located at the end of the head that is facing the display surface.

The acquisition system 4 can be configured to recognize whether the object 6 was played by a hand of the player 5 or by a foot of the player 5. The acquisition system 4 can also be configured to recognize whether the player 5 is holding a racquet in the hand and, in particular, whether the object 6 was played by the racquet. The acquisition system 4 can, moreover, be configured to recognize whether the object 6 was played in accordance with a set of rules belonging to the game device 1.

It is conceivable that the game device 1 is configured such that a rebound sport, in particular squash, tennis, a shooting sport, in particular archery, or American football can be played with the game device 1.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Game device
2 Display surface
3 Sensor system
4 Acquisition system
5 Player
6 Object
7 Target field
8 Game space
9 Target point
10 Trajectory
11 Impact site
12 Target area
13 Floor
14 Intersection point

What is claimed is:

1. A game device, comprising:
a display surface;
a game space assigned to the display surface;
a sensor system configured to detect an impact site of an object on the display surface;
an acquisition system configured to detect a position of at least one of the object and a player in at least a part of the game space; and
a computing unit configured to determine a target field on the display surface based on the position, and
wherein the game device is configured to display the target field on the display surface and to determine whether the impact site lies in the target field.

2. The game device according to claim 1, wherein the computing unit is further configured to:
determine a target area arranged in the game space based on a predetermined rule based on the position, and,
determine, based on the target area, the position, and a ballistic model of the object, the target field such that when the player plays the object towards the target field, the object enters the target area after bouncing back from the display surface.

3. The game device according to claim 2, wherein the computing unit is further configured to:
determine a target point representative for the target area,
calculate, based on the ballistic model, a trajectory of the object extending from the position of the object via the display surface to the target point, and
determine the target field about an intersection point of the trajectory on the display surface.

4. The game device according to claim 2, wherein, in a case in which the acquisition system is not configured to determine the position of the object, the computing unit is configured to:
determine the position of the object depending on the position of the player, and
equate the position of the object to the position of the player.

5. The game device according to claim 2, wherein the ballistic model describes a force-free movement of the object.

6. The game device according to claim 2, wherein the ballistic model comprises an initial speed for the object at the position of the object or a final speed for the object at a target point.

7. The game device according to claim 2, wherein the ballistic model comprises an acceleration due to gravity.

8. The game device according to claim 2, wherein the ballistic model takes an energy loss of kinetic energy of the object due to bouncing-back from the display surface into consideration.

9. The game device according to claim 2, wherein a plurality of predetermined rules are stored in the computing unit, each of which has a different degree of difficulty for the player when playing with the game device.

10. The game device according to claim 1, wherein the acquisition system is configured to determine a number of players.

11. The game device according to claim 2, wherein the acquisition system is configured to determine a number of players, and a different one of predetermined rules or a different set of the predetermined rules is stored in each case in the computing unit for each number of players.

12. The game device according to claim 1, wherein the acquisition system is configured to determine positions of at least one of the object and the player or of at least two objects or of at least two players.

13. The game device according to claim 2, wherein:
the acquisition system is configured to determine positions of at least two players, and
the computing unit is configured to determine the target area based on the positions of the at least two players.

14. The game device according to claim 1, wherein the acquisition system is configured to determine an eye point position of an eye point of the player in the part of the game space and to adjust a perspective of an image displayed on the display surface to the eye point position.

15. The game device according to claim 1, wherein the acquisition system is configured to recognize whether the object was played by a hand of the player or by a foot of the player.

16. The game device according to claim 1, wherein the acquisition system is configured to recognize whether the player is holding a racquet in a hand and whether the object was played by the racquet.

17. The game device according to claim 1, wherein the acquisition system is configured to recognize whether the object was played in accordance with a set of rules belonging to the game device.

18. The game device according to claim 1, wherein the object is a ball, a medicine ball, or a frisbee.

19. The game device according to claim 1, wherein the game device is configured such that a rebound sport, such as squash, tennis, volleyball, a shooting sport, archery, or American football can be played with the game device.

20. An apparatus, comprising:
two game devices according to claim 1, and
wherein the apparatus is configured to display the position acquired in one of the two game devices in another one of the two game devices on the display surface of the other one of the two game devices.
